(19) United States
(12) Patent Application Publication
(10) Pub. No.: US 2010/0295471 A1
(43) Pub. Date: Nov. 25, 2010

(54) CURRENT BALANCING APPARATUS

(75) Inventors: Keita ISHIKURA, Niiza-shi (JP); Shinji Aso, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/785,769

(22) Filed: May 24, 2010

(30) Foreign Application Priority Data
May 25, 2009 (JP) 2009-125027
Mar. 17, 2010 (JP) 2010-060641

(51) Int. Cl. H05B 41/36

(52) U.S. Cl. 315/294

(57) ABSTRACT

A current balancing apparatus includes a power supply unit 10 to output an alternating current and a plurality of series circuits connected to an output of the power supply unit. Each of the series circuits has at least one winding N1 (S1) and a voltage multiplier rectifier having rectifiers D1 and D11 (D2 and D12) and capacitors C1 and C11 (C2 and C12). Outputs of the voltage multiplier rectifiers are connected to loads LD1 and LD2, respectively. Each of the loads has loads LED1a to LED1e (LED2a to LED2e). Currents passing through the loads are balanced by electromagnetic force occurring on the at least one winding.

### BACKGROUND OF THE INVENTION

1. Field of the Invention

The present invention relates to a current balancing apparatus to balance currents passed to a plurality of loads that are connected in parallel with one another.

2. Description of the Related Art

To light LEDs (light emitting diodes) connected in series, Japanese Unexamined Patent Application Publications No. 2004-319583 (Patent Document 1) and No. 2006-12659 (Patent Document 2) disclose LED lighting apparatuses.

The LED lighting apparatus of the Patent Document 1 handles LED units that are connected in parallel with one another and each include LEDs connected in series. The LEDs in each LED unit have different forward voltages Vf, and therefore, the LED units cause different voltage drops when they are driven. This results in unbalancing currents passing through the LED units connected in parallel. To cope with this problem, the related art of the Patent Document 1 employs a constant current circuit to provide a constant current to each LED unit, thereby balancing the currents passing through the LED units.

The discharge lamp lighting apparatus disclosed in the Patent Document 2 employs transformers to balance currents passing through CCFLs (cold cathode fluorescent lamps) connected in parallel. Each CCFL is driven with an alternating current, and therefore, each balancing transformer passes a sinusoidal current. Each CCFL is connected in series with the balancing transformer and secondary windings of the balancing transformers are connected into a closed circuit to balance the currents.

### SUMMARY OF THE INVENTION

According to the related art of the Patent Document 1, the constant current circuit causes a loss due to the voltage drop differences among the LED units.

The related art of the Patent Document 2 may not cause a loss due to voltage variations among the CCFLs because the related art employs the balancing transformers to balance currents. The balancing transformers, however, are unable to balance direct currents needed by LEDs that pass only direct currents. The balancing transformers are effective for higher frequencies but they are ineffective for lower frequencies. The balancing transformers are saturated with direct current, and therefore, are inapplicable to direct current.

The present invention provides a current balancing apparatus capable of balancing currents passing through loads having different impedances without increasing a loss or deteriorating efficiency.

According to an aspect of the present invention, the current balancing apparatus includes a power supply unit to output an alternating current and a plurality of series circuits connected to an output of the power supply unit. Each of the series circuits includes at least one winding and a voltage multiplier rectifier having rectifiers and capacitors. Outputs of the voltage multiplier rectifiers are connected to loads, respectively. Each of the loads includes at least one load element. Currents passing through the load elements of the loads are balanced by electromagnetic force occurring on the at least one winding.

According to another aspect of the present invention, the loads handled by the current balancing apparatus are LEDs of an LED illuminator.

According to still another aspect of the present invention, the current balancing apparatus handles, as a load, an LCD cell of an LCD backlight module.

According to still another aspect of the present invention, the current balancing apparatus handles, as a load, an LCD cell of an LCD display unit.

### BRIEF DESCRIPTION OF THE DRAWINGS

FIG. 1 is a schematic diagram illustrating a current balancing apparatus according to Embodiment 1 of the present invention;

FIG. 2 is a schematic diagram illustrating a current balancing apparatus according to Embodiment 2 of the present invention;

FIG. 3 is a schematic diagram illustrating a current balancing apparatus according to Embodiment 3 of the present invention;

FIG. 4 is a schematic diagram illustrating a current balancing apparatus according to Embodiment 4 of the present invention;

FIG. 5 is a schematic diagram illustrating a current balancing apparatus according to Embodiment 5 of the present invention;

FIG. 6 is a view illustrating an example of a half-wave voltage doubler rectifier;

FIG. 7 is a view illustrating an example of a half-wave voltage tripler rectifier;

FIG. 8 is a view illustrating an example of a half-wave voltage quadrupler rectifier;

FIG. 9 is a view illustrating an example of a full-wave voltage multiplier rectifier;

FIG. 10 is a schematic diagram illustrating a current balancing apparatus according to Embodiment 6 of the present invention;

FIG. 11 is a schematic diagram illustrating a current balancing apparatus according to Embodiment 7 of the present invention;

FIG. 12 is a timing chart explaining operation of the current balancing apparatus of Embodiment 7;

FIG. 13 is a timing chart explaining operation of the current balancing apparatus of Embodiment 7;

FIG. 14 is a graph illustrating a relationship between a leakage inductance Lr2 of a transformer T0 and a current variation;

FIGS. 15A and 15B are schematic diagrams illustrating current balancing apparatuses according to Embodiment 8 of the present invention and a comparative example; and

FIG. 16 is a graph illustrating a comparison of current variation in an LED driver between the use of a coil and the use of a leakage inductance of a transformer.

### DESCRIPTION OF THE PREFERRED EMBODIMENT

Current balancing apparatuses according to embodiments of the present invention and power supply apparatuses employing the same will be explained in detail with reference to the drawings.

As mentioned above, a transformer is able to balance alternating currents but is unable to balance direct currents of a DC driver for driving LEDs. To cope with this problem, the current balancing apparatus according to the present invention includes a power supply unit to output an alternating current and a plurality of series circuits connected to an output of the power supply unit. Each of the series circuits includes at least one winding and a voltage-multiplier-rectifier having rectifiers and capacitors. Outputs of the voltage multiplier rectifiers are connected to loads, respectively. Each of the loads includes at least one load element. Currents passing through the load elements of the loads are balanced in terms of electromagnetic force occurring on the at least one winding.

In the following explanation, loads handled by the current balancing apparatus are LEDs and their impedances have variations.

### Embodiment 1

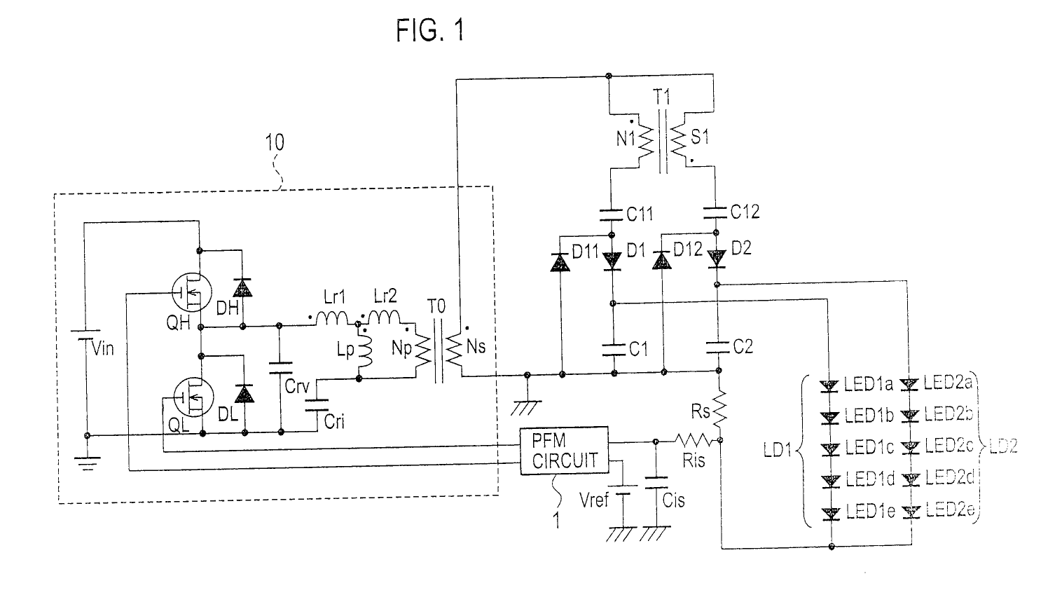

FIG. 1 is a schematic diagram illustrating a current balancing apparatus according to Embodiment 1 of the present invention. A power supply unit 10 supplies a sinusoidal alternating current and includes a DC power source Vin and a series circuit that is connected to both ends of the DC power source Vin and includes switching elements QH and QL each being a MOSFET.

A connection point of the switching elements QH and QL is connected to a series resonant circuit including a primary winding Np of a transformer T0 and a current resonant capacitor Cri. The transformer T0 has impedance elements, i.e., leakage inductances Lr1 and Lr2. The transformer T0 involves an excitation inductance Lp. The switching elements QL and QH are alternately turned on/off so that a secondary winding Ns of the transformer T0 supplies a sinusoidal alternating current created by a resonance of the leakage inductances Lr1 and Lr2 and current resonant capacitor Cri.

A first end of the secondary winding Ns of the transformer T0 is connected to a first end of a winding N1. A second end of the winding N1 is connected through a capacitor C11 to an anode of a diode D1 and a cathode of a diode D11, the diodes D1 and D11 half-wave-rectifying the alternating current. Connected between a cathode of the diode D1 and a second end of the secondary winding Ns is a capacitor C1. Both ends of the capacitor C1 are connected to a series circuit including a load LD1 and a resistor Rs. The load LD1 includes LEDs LED1a to LED1e as load elements. An anode of the diode D11 is connected to the second end of the secondary winding Ns, capacitor C1, and resistor Rs. The capacitors C1 and C11 and diodes D1 and D11 form a first half-wave voltage doubler rectifier.

According to the present embodiment, the winding N1 and first half-wave voltage doubler rectifier form a first series circuit. The secondary winding Ns and first half-wave voltage doubler rectifier form a series circuit. An output of the first half-wave voltage doubler rectifier is connected to the load LD1.

The first end of the secondary winding Ns of the transformer T0 is connected to a first end of a winding S1. A second end of the winding S1 is connected through a capacitor C12 to an anode of a diode D2 and a cathode of a diode D12, the diodes D2 and D12 half-wave-rectifying the alternating current. Connected between a cathode of the diode D2 and the second end of the secondary winding Ns is a capacitor C2. Both ends of the capacitor C2 are connected to a series circuit including a load LD2 and the resistor Rs. The load LD2 includes LEDs LED2a to LED2e as load elements. An anode of the diode D12 is connected to the second end of the secondary winding Ns, capacitor C2, and resistor Rs. The capacitors C2 and C12 and diodes D2 and D12 form a second half-wave voltage doubler rectifier.

According to the present embodiment, the winding S1 and second half-wave voltage doubler rectifier form a second series circuit. The secondary winding Ns and second half-wave voltage doubler rectifier form a series circuit. An output of the second half-wave voltage doubler rectifier is connected to the load LD2.

The windings N1 and S1 are electromagnetically coupled with each other and form a transformer T1. The LEDs have different forward voltages (Vf), and therefore, the loads LD1 and LD2 according to the present embodiment have impedance variation.

The current balancing apparatus illustrated in FIG. 1 has a current detector to detect currents of the series circuits, a comparator to compare a current value detected by the current detector with a reference voltage, and a controller to control the alternating current according to an output from the comparator.

The current detector is the resistor Rs arranged between the load LD1 (LD2) and the secondary winding Ns. A connection point of the load LD1 (LD2) and resistor Rs is connected to an input end of a filter circuit including a resistor Ris and a capacitor Cis. The comparator and controller are provided by a PFM circuit 1. A first input terminal of the PFM circuit 1 is connected to an output end of the filter circuit and a second input terminal of the PFM circuit 1 is connected to a reference voltage Vref that is a positive voltage.

The resistor Rs collectively detects currents passing through the loads LD1 and LD2 and outputs a current detected value through the filter circuit to the PFM circuit 1. The PFM circuit 1 compares the current detected value with the reference voltage Vref, and according to an error between them, controls an ON/OFF frequency of the switching elements QH and QL so that constant currents are provided to the loads.

Operation of the current balancing apparatus according to Embodiment 1 will be explained. When the switching element QL is switched from OFF to ON, the secondary winding Ns that is the output of the power supply unit 10 provides a negative voltage to counterclockwise pass a current through a route extending along Ns (negative pole), D11, C11, N1, and Ns (positive pole) and a current through a route extending along Ns (negative pole), D12, C12, S1, and Ns (positive pole). The primary winding N1 and secondary winding S1 of the transformer T1 are electromagnetically coupled with each other so that the currents passed through them balance with each other. Accordingly, the capacitors C11 and C12 are charged with the equal currents. At this time, the current resonant capacitor Cri and leakage inductance “Lr1+Lr2” resonate to supply a sinusoidal half-wave current.

Thereafter, the switching element QH is switched from OFF to ON and the secondary winding Ns at the output of the power supply unit 10 provides a positive voltage to clockwise pass a current through a route extending along Ns (positive pole), N1, C11, D1, C1, and Ns (negative pole) and a current through a route extending along Ns (positive pole), S1, C12, D2, C2, and Ns (negative pole).

Since the primary winding N1 and secondary winding S1 of the transformer T1 are electromagnetically coupled with each other, the currents passing through them balance with each other. Accordingly, the capacitors C1 and C2 are charged with the equal currents. Consequently, the load LD1 connected to the capacitor C1 and the load LD2 connected to the capacitor C2 receive the balanced currents even if the loads LD1 and LD2 have impedance variation.

A current passing through the switching element QH increases as time passes due to a resonance of the current resonant capacitor Cri, excitation inductance Lp, and leakage inductance Lr1, to charge the current resonant capacitor Cri.

Embodiment 1 uses electromagnetic force occurring on windings to balance currents, and therefore, a loss may occur due to winding resistance. This loss, however, is smaller than that caused by the constant current circuit of the Patent Document 1. Namely, Embodiment 1 reduces a loss in the current balancing apparatus.

According to the present embodiment, each of the loads LD1 and LD2 contains a plurality of LEDs connected in series to constitute an illuminator. Embodiment 1 is capable of supplying balanced currents to the loads LD1 and LD2 to let the LEDs uniformly emit light, thereby uniformly illuminating, for example, a liquid crystal display (LCD).

Compared with arranging a full-wave rectifier on the secondary side of the transformer T0 to provide an alternating current to the windings N1 and S1, the arrangement of Embodiment 1 simplifies the transformer T0, reduces the number of transformers used to balance currents, and saves the cost of the current balancing apparatus.

If the diode D11 (D12) and capacitor C11 (C12) are not used, there will be a problem. Namely, when the transformer T0 inverts to increase a voltage at the negative pole of the secondary winding Ns higher than a voltage at the positive pole thereof, the diode D1 (D2) serving as a rectifying element receives a reverse voltage composed of a rectified voltage of the capacitor C1 (C2), a winding voltage of the secondary winding Ns, and a flyback voltage (reset voltage) generated by the windings N1 and S1 of the transformer T1.

The reset voltage converges to one of the diodes D1 and D2 due to the impedance difference between the loads LD1 and LD2 and increases as the number of the parallel-connected series circuits each involving a winding, rectifying element, and capacitor increases. Namely, as the number of the parallel-connected series circuits each involving a winding, rectifying element, and capacitor increases, each rectifying element is required a higher reverse voltage withstanding ability.

On the other hand, Embodiment 1 employing the diode D11 (D12) and capacitor C11 (C12) provides a current passing through the diode D11 (D12) and capacitor C11 (C12) when the transformer T0 inverts. This results improperly resetting the transformer T1, and therefore, the reverse voltage withstanding ability of the diode D1 (D2) is not affected by the reset voltage of the transformer T1. Consequently, Embodiment 1 can employ rectifying elements of low reverse voltage withstanding ability to increase the numbers of the parallel-connected series circuits and parallel-connected loads.

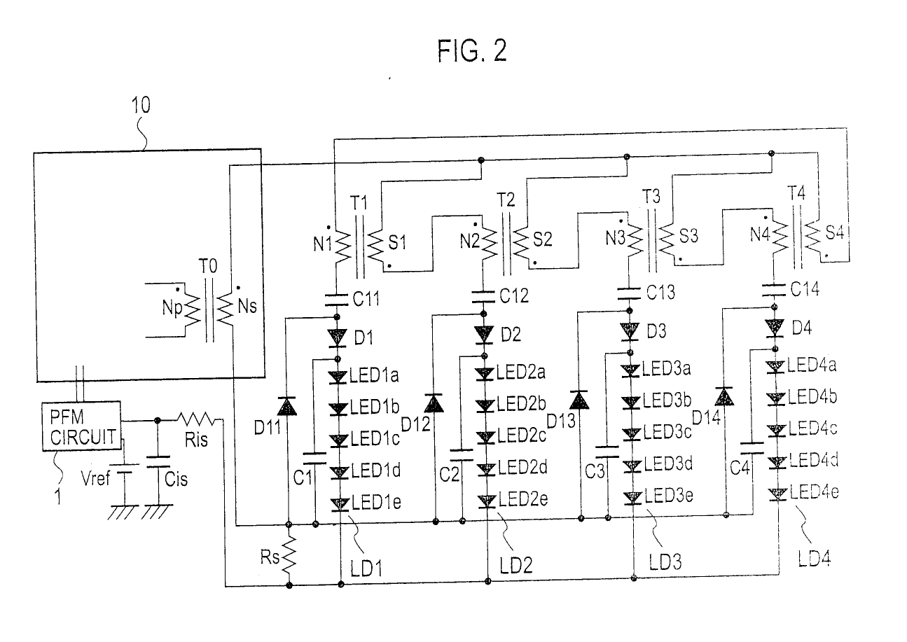

Embodiments 2 to 5 to be explained with reference to FIGS. 2 to 5 connect a power supply unit 10 to a plurality of series circuits each having a half-wave voltage doubler rectifier. Each of these embodiments electromagnetically couples transformers in such a way as to balance currents passed to a plurality of loads that are connected to the half-wave voltage doubler rectifiers.

### Embodiment 2

FIG. 2 is a schematic diagram illustrating a current balancing apparatus according to Embodiment 2 of the present invention. An output of a power supply unit 10 is connected to a first series circuit including a winding S4, a winding N1, and a first half-wave voltage doubler rectifier having capacitors C1 and C11 and diodes D1 and D11, a second series circuit including a winding S1, a winding N2, and a second half-wave voltage doubler rectifier having capacitors C2 and C12 and diodes D2 and D12, a third series circuit including a winding S2, a winding N3, and a third half-wave voltage doubler rectifier having capacitors C3 and C13 and diodes D3 and D13, and a fourth series circuit including a winding S3, a winding N4, and a fourth half-wave voltage doubler rectifier having capacitors C4 and C14 and diodes D4 and D14.

Both ends of the capacitor C1 (C2, C3, C4) are connected to a series circuit including a load LD1 (LD2, LD3, LD4) and a resistor Rs. The load LD1 (LD2, LD3, LD4) has LEDs LED1a to LED1e (LED2a to LED2e, LED3a to LED3e, LED4a to LED4e) as load elements. An anode of the diode D11 (D12, D13, D14) is connected to a second end of a secondary winding Ns and the capacitor C1 (C2, C3, C4).

The windings N1 (N2, N3, N4) and S1 (S2, S3, S4) are electromagnetically coupled with each other to balance currents half-wave-rectified by the diodes and form a transformer T1 (T2, T3, T4).

Each of the series circuits includes two windings connected in series. The windings of the series circuits are electromagnetically coupled as primary and secondary windings to form transformers.

Embodiment 2 provides the same effect as Embodiment 1. Since each series circuit involves two windings, Embodiment 2 can reduce and equalize the sizes of the balancing transformers.

### Embodiment 3

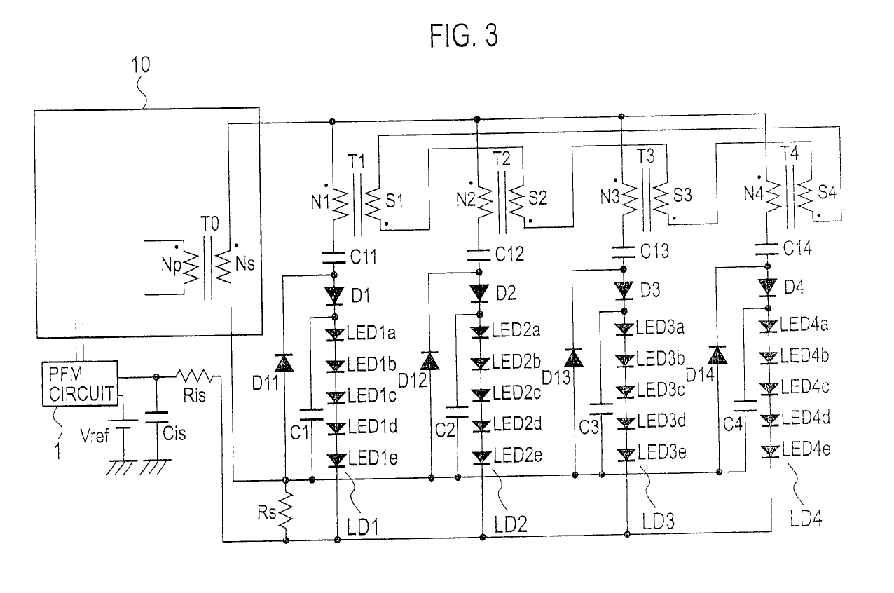

FIG. 3 is a schematic diagram illustrating a current balancing apparatus according to Embodiment 3 of the present invention. An output of a power supply unit 10 is connected to a first series circuit including a winding N1 and a first half-wave voltage doubler rectifier having capacitors C1 and C11 and diodes D1 and D11, a second series circuit including a winding N2 and a second half-wave voltage doubler rectifier having capacitors C2 and C12 and diodes D2 and 012, a third series circuit including a winding N3 and a third half-wave voltage doubler rectifier having capacitors C3 and C13 and diodes D3 and D13, and a fourth series circuit including a winding N4 and a fourth half-wave voltage doubler rectifier having capacitors C4 and C14 and diodes D4 and D14.

Windings S1, S2, S3, and S4 are connected in a closed loop. The windings N1 (N2, N3, N4) and S1 (S2, S3, S4) are electromagnetically coupled with each other to form a transformer T1 (T2, T3, T4). Namely, each of the series circuits has a winding and the windings of the series circuits are electromagnetically coupled with windings that are connected in series to form a closed loop. As a result, the windings S1, S2, S3, and S4 provide equal currents.

Embodiment 3 provides the same effect as Embodiment 1. Embodiment 3 can employ transformers of the same capacity as the balancing transformers.

### Embodiment 4

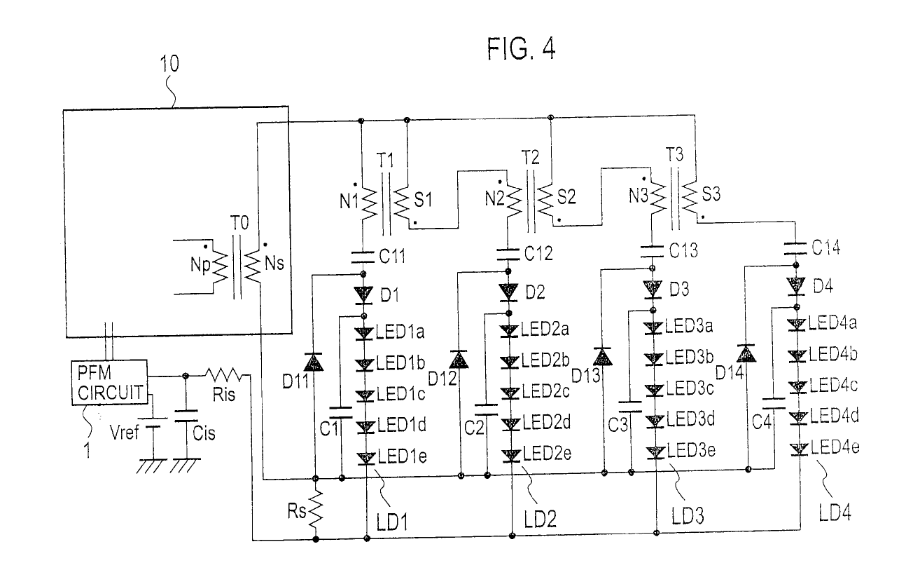

FIG. 4 is a schematic diagram illustrating a current balancing apparatus according to Embodiment 4 of the present invention. An output of a power supply unit 10 is connected to a first series circuit including a winding N1 and a first half-wave voltage doubler rectifier having capacitors C1 and C11 and diodes D1 and D11, a second series circuit including a winding S1, a winding N2, and a second half-wave voltage doubler rectifier having capacitors C2 and C12 and diodes D2 and D12, a third series circuit including a winding S2, a winding N3, and a third half-wave voltage doubler rectifier having capacitors C3 and C13 and diodes D3 and D13, and a fourth series circuit including a winding S3 and a fourth half-wave voltage doubler rectifier having capacitors C4 and C14 and diodes D4 and D14.

Embodiment 4 provides the same effect as Embodiment 1. Embodiment 4 eliminates the transformer T4 having the windings N4 and S4 of Embodiments 2 and 3, thereby reducing the cost of the current balancing apparatus.

### Embodiment 5

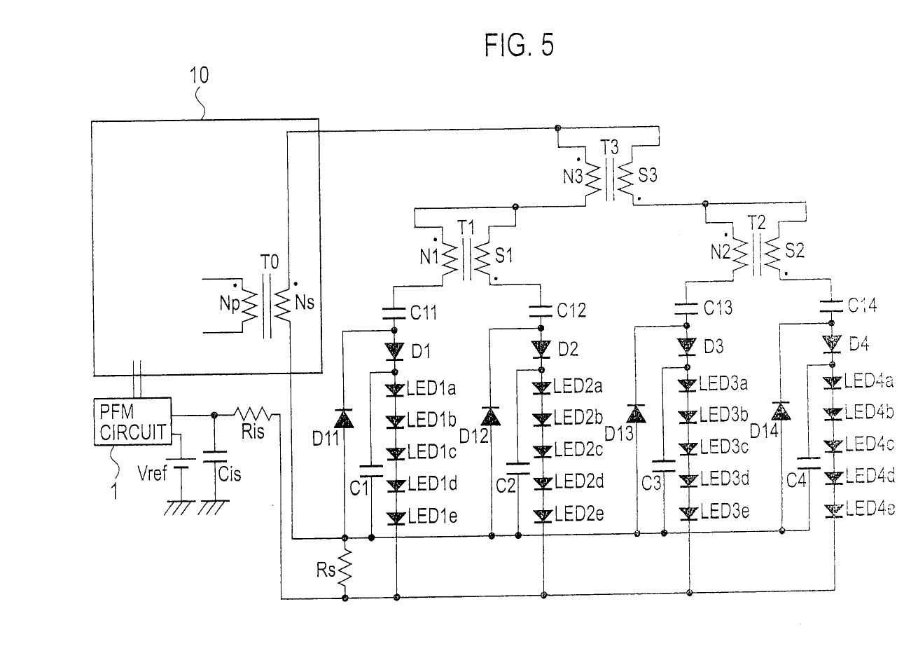

FIG. 5 is a schematic diagram illustrating a current balancing apparatus according to Embodiment 5 of the present invention. An output of a power supply unit 10 is connected to a first series circuit including a winding N3, a winding N1, and a first half-wave voltage doubler rectifier having capacitors C1 and C11 and diodes D1 and D11, a second series circuit including the winding N3, a winding S1, and a second half-wave voltage doubler rectifier having capacitors C2 and C12 and diodes D2 and D12, a third series circuit including a winding S3, a winding N2, and a third half-wave voltage doubler rectifier having capacitors C3 and C13 and diodes D3 and D13, and a fourth series circuit including the winding S3, a winding S2, and a fourth half-wave voltage doubler rectifier having capacitors C4 and C14 and diodes D4 and D14.

Embodiment 5 provides the same effect as Embodiment 1. Embodiment 5 eliminates the transformer T4 having the windings N4 and S4 of Embodiments 2 and 3, thereby reducing the cost of the current balancing apparatus.

### (Half-Wave Voltage Multiplier Rectifier)

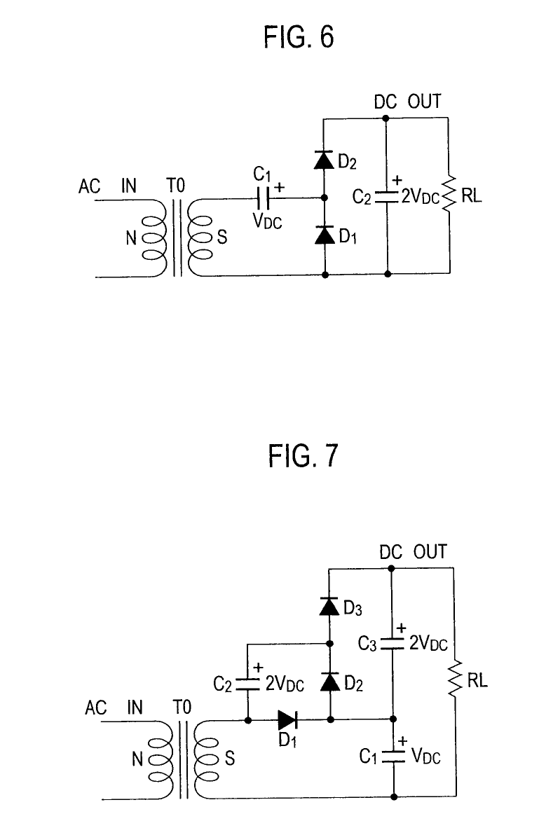

Examples of voltage multiplier rectifiers employable for Embodiments 1 to 5 will be explained. FIG. 6 illustrates an example of a half-wave voltage doubler rectifier. This half-wave voltage doubler rectifier corresponds to any one of the half-wave voltage doubler rectifiers illustrated in FIGS. 1 to 5. In FIG. 6, a transformer T0 receives an AC voltage. A first end of a secondary winding S of the transformer T0 is connected to a first end of a capacitor C1. A second end of the capacitor C1 is connected to a cathode of a diode D1 and an anode of a diode D2.

A cathode of the diode D2 is connected to a first end of a capacitor C2 and a first end of a load RL. An anode of the diode D1 is connected to a second end of the capacitor C2 and a second end of the load RL. An output voltage across the capacitor C2 is a half-wave voltage that is twice as large as a voltage VDC across the capacitor C1.

FIG. 7 illustrates an example of a half-wave voltage tripler rectifier. In FIG. 7, a transformer T0 receives an AC voltage. A first end of a secondary winding S of the transformer T0 is connected to an anode of a diode D1 and a first end of a capacitor C2. A cathode of the diode D1 is connected to an anode of a diode D2, a first end of a capacitor C1, and a first end of a capacitor C3. A second end of the capacitor C1 is connected to a second end of the secondary winding S and a first end of a load RL.

A cathode of the diode D2 is connected to a second end of the capacitor C2 and an anode of a diode D3. A cathode of the diode D3 is connected to a second end of the capacitor C3 and a second end of the load RL. An output voltage across a series circuit including the capacitors C1 and C3 is a half-wave voltage that is three times as large as a voltage VDC across the capacitor C1.

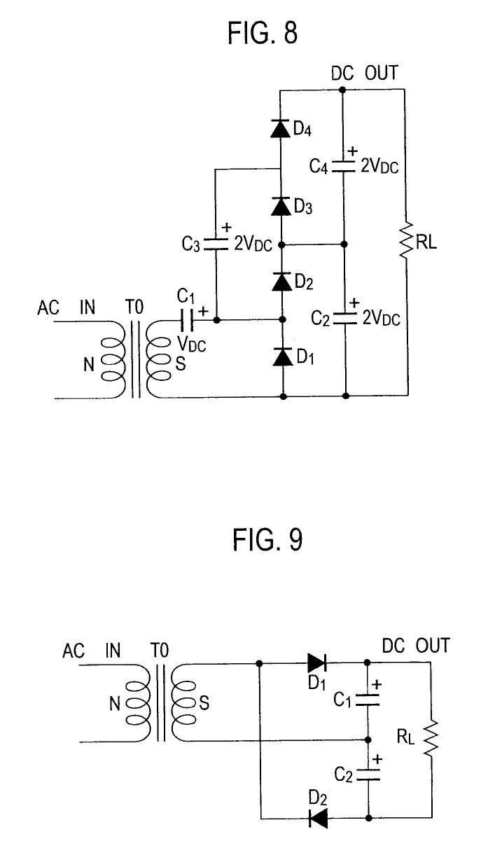

FIG. 8 illustrates an example of a half-wave voltage quadrupler rectifier. In FIG. 8, a transformer T0 receives an AC voltage. A first end of a secondary winding S of the transformer T0 is connected to a first end of a capacitor C1. A second end of the capacitor C1 is connected to a first end of a capacitor C3, a cathode of a diode D1, and an anode of a diode D2.

An anode of the diode D1 is connected to a second end of the secondary winding S, a first end of a capacitor C2, and a first end of a load RL. A cathode of the diode D2 is connected to a second end of the capacitor C2, a first end of a capacitor C4, and an anode of a diode D3. A cathode of the diode D3 is connected to a second end of the capacitor C3 and an anode of a diode D4. A cathode of the diode D4 is connected to a second end of the capacitor C4 and a second end of the load RL. An output voltage across a series circuit including the capacitors C2 and C4 is a half-wave voltage that is four times as large as a voltage VDC across the capacitor C1.

FIG. 9 illustrates an example of a full-wave voltage multiplier rectifier. In FIG. 9, a transformer T0 receives an AC voltage. A first end of a secondary winding S of the transformer T0 is connected to an anode of a diode D1 and a cathode of a diode D2.

A cathode of the diode D1 is connected to a first end of a capacitor C1 and a first end of a load RL. A second end of the secondary winding S is connected to a second end of the capacitor C1 and a first end of a capacitor C2. A second end of the capacitor C2 is connected to an anode of the diode D2 and a second end of the load RL. An output voltage across a series circuit including the capacitors C1 and C2 is a full-wave that is twice as large as a voltage of the secondary winding S.

The examples of voltage multiplier rectifiers explained above are not intended to limit the present invention. The current balancing apparatuses according to the present invention may employ any other voltage multiplier rectifiers.

### Embodiment 6

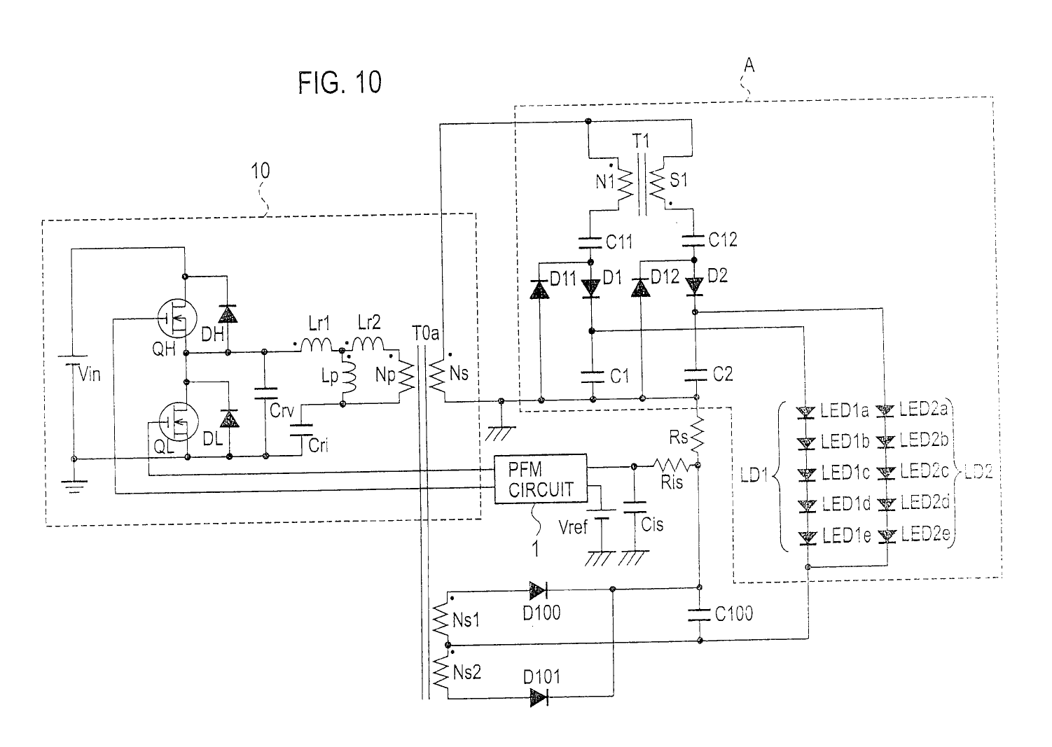

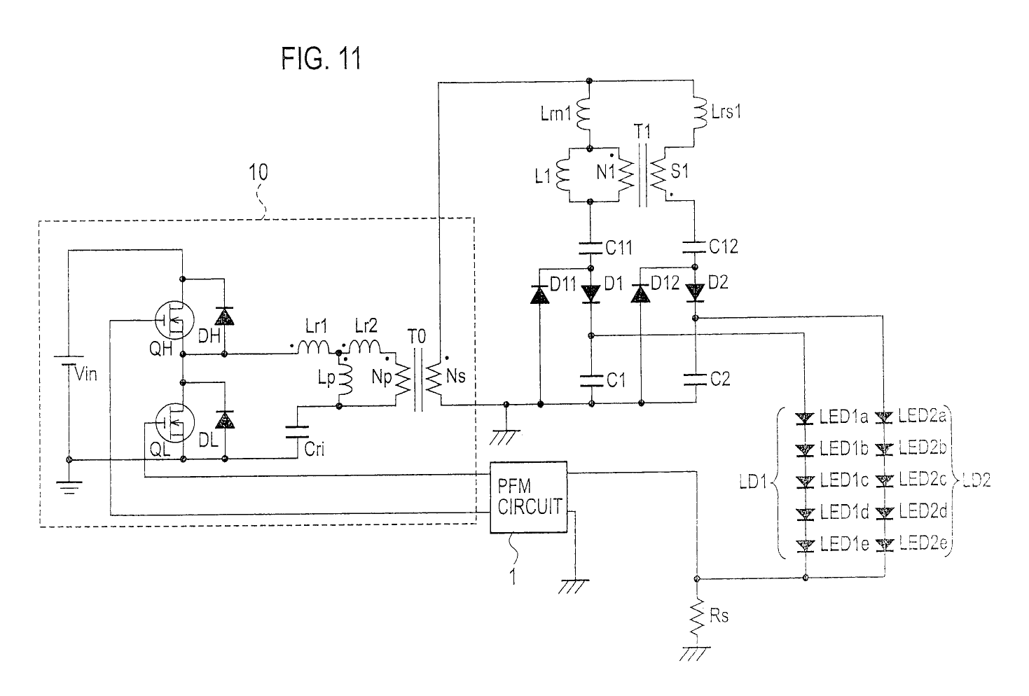

FIG. 10 is a schematic diagram illustrating a current balancing apparatus according to Embodiment 6 of the present invention. Embodiment 6 of FIG. 10 differs from Embodiment 1 of FIG. 1 in that Embodiment 6 employs a transformer T0a instead of the transformer T0 and additionally uses diodes D100 and D101 and a capacitor C100.

The transformer T0a has a primary winding Np and a secondary winding Ns. In addition, the transformer T0a has a first secondary winding Ns1 and a second secondary winding Ns2 that are connected in series. A first end of the first secondary winding Ns1 is connected to an anode of the diode D100. A cathode of the diode D100 is connected to a cathode of the diode D101, a first end of the capacitor C100, and resistors Rs and Ris.

A second end of the first secondary winding Ns1 and a first and of the second secondary winding Ns2 are connected to a second end of the capacitor C100, a first end of a load LD1 and a first end of a load LD2. The load LD1 (LD2) has LEDs LED1a to LED1e (LED2a to LED2e). A second end of the secondary winding Ns2 is connected to an anode of the diode D101.

The capacitor C100 is replaceable with a voltage source. Voltages of capacitors C1 and C2 are adjusted to equalize the voltages even if the loads have different impedances. The voltage of the capacitor C1 (C2) is equal to the sum of a voltage of the load LD1 (LD2), a voltage of the resistor Rs, and a voltage of the capacitor C100. Due to this, the withstand voltage of each of the diodes used in the current balancing apparatus of the present embodiment can be reduced, so that the number of LEDs to be connected in series can be increased. When the number of LEDs is unchanged, the numbers of the balancing transformers and voltage multiplier rectifiers can be decreased.

If an abnormality occurs in the loads, the voltage of the capacitor C1 (C2) will change. Namely, if the voltage of the capacitor C1 (C2) deviates out of a predetermined range, an abnormality in the loads is detectable. The voltage to be detected at the time of abnormality is low, and therefore, a protective circuit is manufacturable at low cost.

The voltage multiplier rectifier of the current balancing apparatus of Embodiment 6 may be any one of those illustrated in FIGS. 2 to 5.

The balancing transformer in a section A of the current balancing apparatus of Embodiment 6 may be replaced with any one of the balancing transformers illustrated in FIGS. 2 to 5.

### Embodiment 7

FIG. 11 is a schematic diagram illustrating a current balancing apparatus according to Embodiment 7 of the present invention. Compared with Embodiment 1 of FIG. 1, Embodiment 7 of FIG. 11 separates the transformer T1 of Embodiment 1 into an ideal transformer T1 having windings N1 and S1, an excitation inductance, and a leakage inductance. The balancing of currents passed to loads LD1 (LEDs LED1a to LED1e) and LD2 (LEDs LED2a to LED2e) with this configuration will be explained.

It is preferable that a PFM circuit 1 controls a switching frequency of switching elements QH and QL higher than a resonant frequency of a power supply unit 10 in a case where the load LD1 or LD2 is in a steady state. In this regard, a comparative example assuming that the switching frequency is lower than the resonant frequency, i.e., about 0.7 times the resonant frequency will be explained with the use of the current balancing apparatus of FIG. 11. The resonant frequency is determined by the excitation inductance Lp and leakage inductance “Lr1+Lr2” of a transformer T0 and a resonant capacitor Cri. The leakage inductance Lr2 includes an inductance on the secondary side of the transformer T0. Namely, the resonant frequency is determined by the inductance of the transformer T0, the leakage inductance “Lrn1+Lrs1” of the transformer T1, and the current resonant capacitor Cr1.

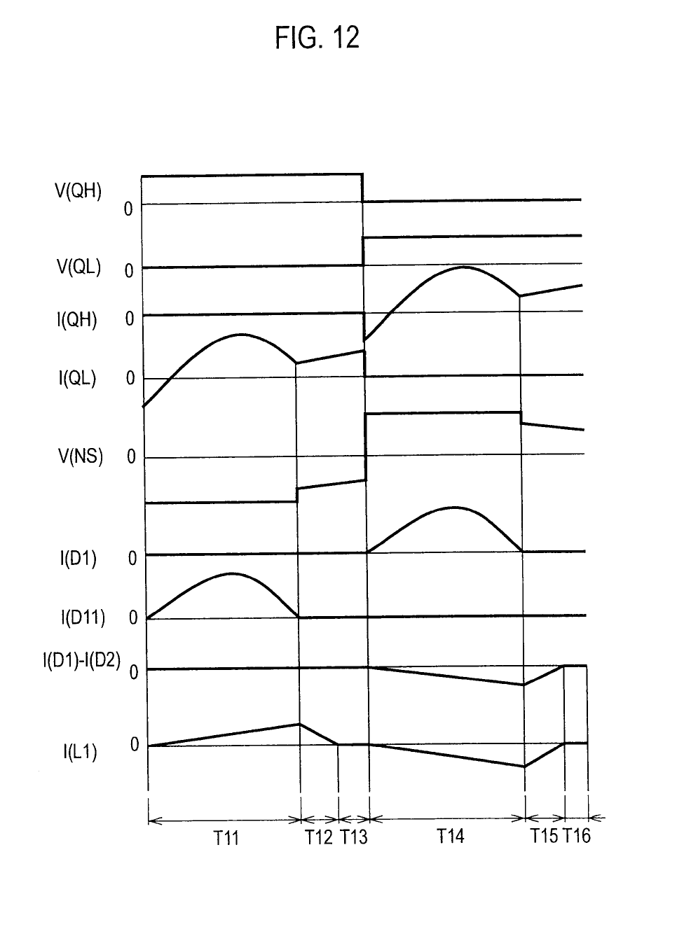

Operation of the comparative example will be explained with reference to a timing chart of FIG. 12.

In FIG. 12, V(QH) is a drain-source voltage of the switching element QH, V(QL) is a drain-source voltage of the switching element QL, I(QH) is a drain-source current of the switching element QH, I(QL) is a drain-source current of the switching element QL, V(Ns) is a voltage of a secondary winding Ns of the transformer T0, I(D1) is a current passing through a diode D1, I(D11) is a current passing through a diode D11, I(D1)−I(D2) is a difference between the currents passing through the diodes D1 and D2, and I(L1) is a current passing through the excitation inductance L1 of the transformer T1.

Operating states of the comparative example are divided into six periods T11 to T16 depending on ON/OFF states of the switching elements QH and QL and voltages applied to the transformers T1 and T0. In the period T11, the switching element QH is OFF and the switching element QL is ON. A current on the primary side of the transformer T0 passes through a path extending along Cri, Lp (Np, Lr2), Lr1, and QL (DL). Appearing at the winding start of each of the windings Np and Ns of the transformer T0 is a negative voltage, and therefore, a current on the secondary side passes through a path extending along Ns, D11, C11, and N1 (L1) and a path extending along Ns, D12, C12, and S1.

The LEDs in the loads LD1 and LD2 have forward voltages Vf that may vary from one to another. The loads LD1 and LD2 have forward voltage totals Vf(LD1) and Vf(LD2), respectively. If there is a relationship of Vf(LD1)>Vf(LD2), V(L1) at the winding start of the winding N1 is positive. Accordingly, the excitation current I(L1) passing through the excitation inductance L1 increases at a gradient of V(L1)/L1.

In the period T12, the switching element QH is OFF and the switching element QL is ON, like in the period T11. The resonant frequency in the period T12, however, is produced by the inductance “Lr1+Lp” and the current resonant capacitor Cri. A current path on the primary side of the transformer T0 is the same as that in the period T11. On the secondary side of the transformer T0, however, a current passes through a path extending along Ns, D12, C12, and S1 and a path extending along L1 and N1. The current passing on the secondary side of the transformer T0 is a current accumulated in and discharged from the excitation inductance L1, and when the excitation current becomes zero, the period T12 ends.

In the period T13, the switching element QH is OFF and the switching element QL is ON, like in the periods T11 and T12. A current on the primary side of the transformer T0 is the same as that in the period T11. No current passes through the windings Np and Ns of the transformer T0. On the secondary side of the transformer T0, no current passes through the diodes D1, D2, D11, and D12 and no current passes through the excitation inductance L1.

In the period T14, the switching element QH is ON and the switching element QL is OFT. On the primary side of the transformer T0, a current passes through a path extending along Vin, QH (DH), Lr1, Lp (Np, Lr2), and Cri. Appearing at the winding start of each of the windings Np and Ns of the transformer T0 is a negative voltage. Accordingly, a current on the secondary side of the transformer T0 passes through a path extending along Ns, N1 (L1), C11, D1, and C1 (LD1) and a path extending along Ns, S1, C12, D2, and C2 (LD2). At this time, V(L1) at the winding start of the winding N1 is negative, and therefore, the current I(L1) decreases at a gradient of |V(L1)/L1|.

In the period T15, the switching element QH is ON and the switching element QL is OFF, like in the period T14. The resonant frequency in the period T15, however, is produced by the inductance “Lr1+Lp” and the current resonant capacitor Cri. A current on the primary side of the transformer T0 is the same as that in the period T14. A current on the secondary side of the transformer T0 passes through a path extending along Ns, S1, C12, D2, and C2 (LD2) and a route extending along L1 and N1. The current passing on the secondary side of the transformer T0 in the period T15 is a current accumulated in and discharged from the excitation inductance L1, and when the excitation current becomes zero, the period T15 ends.

In the period T16, the switching element QH is ON and the switching element QL is OFF, like in the periods T14 and T15. A current on the primary side of the transformer T0 is the same as in the period T14. No current passes through the windings Np and Ns of the transformer T0. Like in the period T13, no current passes through the diodes D1, D2, D11, and D12 and no current passes through the excitation inductance L1 on the secondary side of the transformer T0.

The comparative example cyclically repeats the above-mentioned operation. In the periods T11, T12, T13, and T16 among the periods T11 to T16, the diodes D1 and D2 are not conductive. In the periods T14 and T15, the diodes D1 and D2 are conductive and an excitation current passing through the excitation inductance L1 is added to the current I(D1) to cause a difference of current “I(D1)−I(D2)” between the currents I(D1) and I(D2).

An assumption is made in the current balancing apparatus of FIG. 11 that the switching frequency is about twice as large as the resonant frequency determined by the leakage inductance “Lr1+Lr2” of the transformer T0 and the resonant capacitor Cri. In this case, the windings of the transformer T0 are loosely coupled and the leakage inductance Lr2 of the transformer T0 is increased to about 30 times larger than that of the above-mentioned comparative example, thereby reducing the resonant frequency of the power supply unit 10 including the leakage inductance “Lr1+Lr2” and the resonant capacitor Cri.

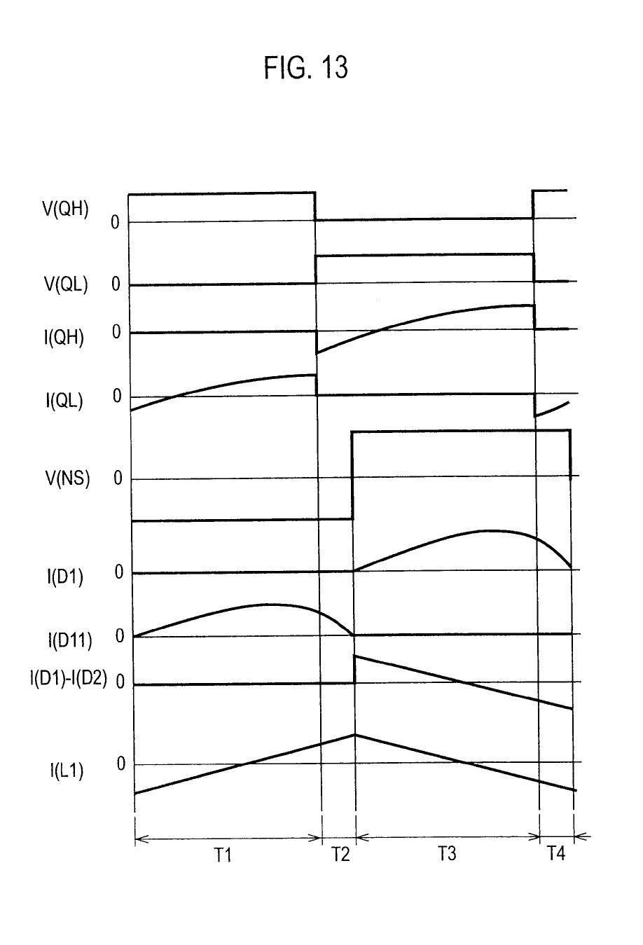

Operation of the current balancing apparatus of the present embodiment will be explained with reference to a timing chart of FIG. 13.

Operating states of the present embodiment are divided into four periods T1 to T4 depending on ON/OFF states of the switching elements QH and QL and voltages applied to the transformers T1 and T0.

In the period T1, the switching element QH is OFF and the switching element QL is ON. A current on the primary side of the transformer T0 passes through a path extending along Cri, Lp (Np, Lr2), Lr1, and QL. Appearing at the winding start of each of the windings Np and Ns of the transformer T0 is a negative voltage. Accordingly, a current on the secondary side of the transformer T0 passes through a path extending along Ns, D11, C11, and N1 (L1) and a path extending along Ns, D12, C12, and S1.

The LEDs in the loads LD1 and LD2 have forward voltages Vf that may vary from one to another. The loads LD1 and LD2 have forward voltage totals Vf(LD1) and Vf(LD2), respectively. If there is a relationship of Vf(LD1)>Vf(LD2), V(L1) at the winding start of the winding N1 is positive. Accordingly, the excitation current I(L1) passing through the excitation inductance L1 increases at a gradient of V(L1)/L1.

In the period T2, the switching element QH is ON and the switching element Q1 is OFF. A current on the primary side of the transformer T0 passes through a path extending along Vin, Cri, Lp (Np, Lr2), Lr1, and QH (DH). Appearing at the winding start of each of the windings Np and Ns of the transformer T0 is a negative voltage, and therefore, a current on the secondary side of the transformer T0 passes through the same two paths as in the period T1.

At this time, V(L1) at the winding start of the winding N1 is positive, and therefore, the excitation current I(L1) increases at a gradient of V(L1)/L1.

In the period T3, the switching element QH is ON and the switching element QL is OFF. On the primary side of the transformer T0, a current passes through a path extending along Vin, QH (DH), Lr1, Lp (NP, Lr2), and Cri. Appearing at the winding start of each of the windings Np and Ns of the transformer T0 is a positive voltage, and therefore, a current on the secondary side of the transformer T0 passes through a path extending along Ns, N1 (L1), C11, D1, and C1 (LD1) and a path extending along Ns, S1, C12, D2, and C2 (LD2). At this time, V(L1) at the winding start of the winding N1 is negative, and therefore, the current I(L1) decreases at a gradient of |V(L1)/L1|.

In the period T4, the switching element QH is OFF and the switching element QL is ON. A current on the primary side of the transformer T0 passes through a path extending along Cri, QL, Lr1, and Lp (Np, Lr2). Appearing at the winding start of each of the windings Np and Ns is a positive voltage, and therefore, a current on the secondary side of the transformer T0 passes through the same two paths as in the period T3.

At this time, V(L1) at the winding start of the winding N1 is negative, and therefore, the current I(L1) decreases at a gradient of |V(L1)/L1|.

The current balancing apparatus according to the present embodiment cyclically repeats the above-mentioned operation. In the periods T1 and T2 among the periods T1 to T4, the diodes D1 and D2 are not conductive. In the periods T3 and T4, the diodes D1 and D2 are conductive and an excitation current passing through the excitation inductance L1 is added to the current I(D1) to produce a difference of current “I(D1)−I(D2)” between the currents I(D1) and I(D2). Unlike the comparative example, an integration of the difference of current “I(D1)−I(D2)” for one cycle (T1 to T4) results in nearly zero because variations are averaged. In this way, if the switching frequency is larger (higher) than the resonant frequency, variations in currents passing through the LEDs of the loads are minimized.

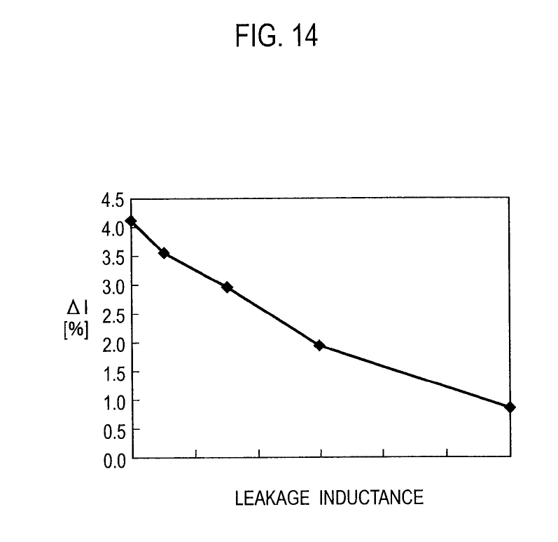

As mentioned above, a relationship between the resonant frequency of the power supply unit 10 and the switching frequency influences variations in currents passing through the LEDs of the loads. This means that the leakage inductance of the transformer T0 influences variations in currents passing through the LEDs of the loads. FIG. 14 is a graph illustrating a relationship between the leakage inductance Lr2 of the transformer T0 and variations in the currents. As is apparent in FIG. 14, the current variation ΔI(I(D1)−I(D2)) decreases as the leakage inductance Lr2 increases.

As mentioned above, the leakage inductance Lr2 includes the inductance on the secondary side of the transformer T0, and therefore, providing the transformer T1 with a loose coupling configuration to increase the leakage inductance has an effect similar to providing the transformer T0 with a loose coupling configuration. Generally, a transformer having primary and secondary windings individually wound around an iron core to reduce a coupling ratio is easy to manufacture at low cost. Accordingly, using a transformer having a large leakage inductance for a current balancing apparatus results in reducing the cost of the apparatus and improving the current accuracy of the apparatus.

### Embodiment 8

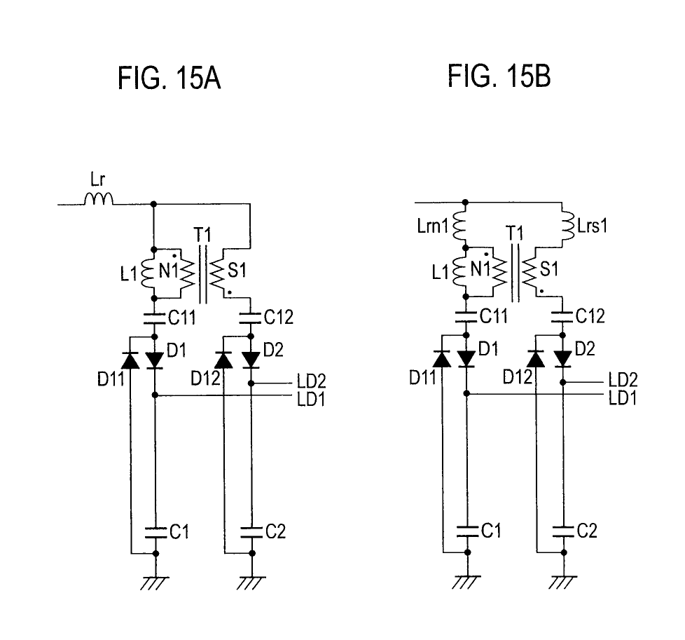

FIG. 15A illustrates a current balancing apparatus according to Embodiment 8 of the present invention and FIG. 15B illustrates a comparative example that uses a leakage inductance of a transformer T1 like Embodiment 7 of FIG. 11. Embodiment 8 of FIG. 15A connects an external coil Lr to a transformer T1 in place of the leakage inductance of the transformer T1 of FIG. 15B.

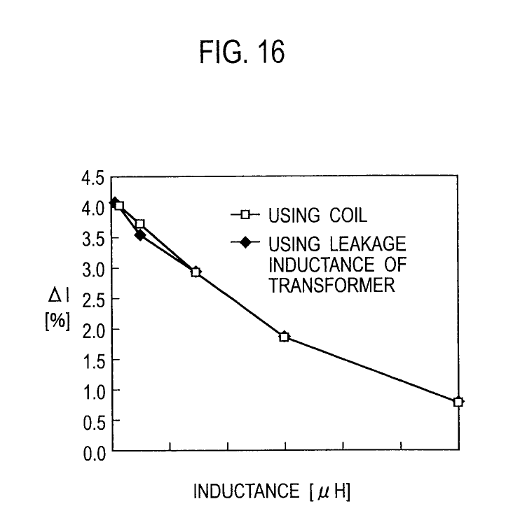

As illustrated in FIG. 16, Embodiment 8 using the coil Lr provides the same effect as the configuration using the leakage inductance of the transformer T1.

The current balancing apparatus according to any one of Embodiments 1 to 8 of the present invention is applicable to, for example, an LED illuminator, an LCD backlight module, and an LCD display unit.

The LED illuminator includes a power conversion unit to convert AC power of a commercial AC power source into optional alternating power and supply an alternating current and a current balancing apparatus connected to an output of the power conversion unit. The current balancing apparatus includes a plurality of series circuits. Each of the series circuits includes at least one winding and a voltage multiplier rectifier having rectifiers and capacitors. Outputs of the voltage multiplier rectifiers are connected to loads, respectively, each of the loads including at least one LED. Currents passing through the LEDs of the loads are balanced in terms of electromagnetic force occurring on the at least one winding.

The LCD backlight module includes an LCD cell, a power conversion unit to convert AC power of a commercial AC power source into optional alternating power and supply an alternating current, and a current balancing apparatus connected to an output of the power conversion unit. The current balancing apparatus includes a plurality of series circuits. Each of the series circuits includes at least one winding and a voltage multiplier rectifier having rectifiers and capacitors. Outputs of the voltage multiplier rectifiers are connected to loads, respectively, each of the loads including at least one LED load to light the LCD cell. Currents passing through the LEDs of the loads are balanced in terms of electromagnetic force occurring on the at least one winding.

The LCD display unit includes an LCD cell, a power conversion unit to convert AC power of a commercial AC power source into optional alternating power and supply an alternating current, and a current balancing apparatus connected to an output of the power conversion unit. The current balancing apparatus includes a plurality of series circuits. Each of the series circuits includes at least one winding and a voltage multiplier rectifier having rectifiers and capacitors. Outputs of the voltage multiplier rectifiers are connected to loads, respectively, each of the loads including at least one LED load to light the LCD cell. Currents passed to the LED load elements of the loads are balanced through electromagnetic force occurring on the at least one winding. The LCD display unit is used for a television set, a monitor, a billboard, or the like.

In this way, the current balancing apparatus according to the present invention is capable of balancing currents supplied from a power supply unit to a plurality of loads with the use of electromagnetic force generated by windings connected in series with the loads. Balancing currents with the use of electromagnetic force generated by windings results in reducing a loss to be caused by differences among the impedances of loads and improving efficiency.

The present invention is applicable to LED illuminators, LED lighting apparatuses to light LED backlights of liquid crystal displays, and the like.

This application claims benefit of priority under 35 USC §119 to Japanese Patent Applications No. 2009-125027, filed on May 25, 2009 and No. 2010-060641, filed on Mar. 17, 2010, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A current balancing apparatus comprising:
a power supply unit configured to output an alternating current; and
a plurality of series circuits connected to an output of the power supply unit, each of the series circuits including at least one winding and a voltage multiplier rectifier having rectifiers and capacitors,
outputs of the voltage multiplier rectifiers being connected to loads, respectively, each of the loads including at least one load element, and
currents passing through the load elements of the loads being balanced by electromagnetic force occurring on the at least one winding.

2. The current balancing apparatus of claim 1, wherein
each of the loads has a rectifying characteristic.

3. The current balancing apparatus of claim 1, wherein
the alternating current is a sinusoidal current.

4. The current balancing apparatus of claim 3, wherein the power supply unit is a resonant power supply unit including:
a first transformer having primary and secondary windings and first and second switching elements connected in series with both ends of a DC power source and controlled to be turned on/off; and
a series unit connected to a connection point of the first and second switching elements and including the primary winding of the first transformer and a resonant capacitor,
the secondary winding of the transformer outputting the alternating current.

5. The current balancing apparatus of claim 4, wherein
the first and second switching elements are turned on/off at a switching frequency higher than a resonant frequency of the power supply unit.

6. The current balancing apparatus of claim 4, wherein:
the at least one winding is of a second transformer; and
at least one of the first transformer and the second transformer has a loose coupling configuration.

7. The current balancing apparatus of claim 1, further comprising:
a current detector configured to detect currents passing through the plurality of series circuits;
a comparator configured to compare a current detected value from the current detector with a reference value; and
a controller configured to control the alternating current according to an output from the comparator.

8. An LED illuminator having the current balancing apparatus according to claim 1 with the loads being LEDs.

9. An LCD backlight module having an LCD cell and the current balancing apparatus according to claim 1 that handles the LCD cell as a load.

10. An LCD display unit having an LCD cell and the current balancing apparatus according to claim 1 that handles the LCD cell as a load.
